(19) United States
(12) Patent Application Publication
(10) Pub. No.: US 2013/0172068 A1
(43) Pub. Date: Jul. 4, 2013

(54) WEARABLE PERSONAL DIGITAL FLEXIBLE CLOUD GAME, MULTIMEDIA, COMMUNICATION AND COMPUTING DEVICE

(71) Applicants: Tiger T G Zhou, Tiburon, CA (US); Dylan T X Zhou, San Gabriel, CA (US); Andrew H B Zhou, Tiburon, CA (US)

(72) Inventors: Tiger T G Zhou, Tiburon, CA (US); Dylan T X Zhou, San Gabriel, CA (US); Andrew H B Zhou, Tiburon, CA (US)

(21) Appl. No.: 13/776,852

(22) Filed: Feb. 26, 2013

Related U.S. Application Data
(63) Continuation-in-part of application No. 13/287,279, filed on Nov. 2, 2011.

(51) Int. Cl. G06F 15/163

(52) U.S. Cl. CPC G06F 15/163
USPC 463/16; 463/42; 463/37; 463/31; 463/35; 463/25; 463/36; 463/29

(57) ABSTRACT

Provided is a wearable personal digital (WPD) flexible cloud game, multimedia, communication and computing device, a method for accessing game and multimedia data and performing communications using the WPD flexible cloud game, multimedia, communication and computing device, and a method for facilitating payments using a WPD flexible cloud game, multimedia, communication and computing device. The WPD flexible cloud game, multimedia, communication and computing device comprises a flexible display, a flexible power source, a processor, a memory unit, and a communication circuit. The processor is configured to communicate with a game and multimedia server and a communication server over a network to transfer game, multimedia and communication data, and transmit, upon a user's request, the game, multimedia and communication data to one or more external devices.

### RELATED APPLICATIONS

This application is a Continuation-In-Part of U.S. patent application Ser. No. 13/287,279, filed on Nov. 2, 2011, titled “METHODS AND SYSTEMS TO ADVERTISE AND SELL PRODUCTS OR SERVICES VIA CLOUD GAMING ENVIRONMENTS,” which is incorporated herein by reference in its entirety for all purposes.

### FIELD

This application relates generally to cloud gaming, multimedia and communication environments and, more specifically, to a flexible cloud game, multimedia, communication and computing device and a method for facilitating payments using the flexible cloud game, multimedia, communication and computing device.

### BACKGROUND

With the development and widespread use of the Internet, many new forms of entertainment and gaming came to existence. One of them, the cloud-based streaming technology, enabled delivering content to user devices on demand. As a part of cloud computing, various entertainment cloud services emerged. One such service is cloud gaming. Cloud gaming allows direct and on-demand streaming of games onto a computer. Thus, the actual game is stored on the game company's server and is streamed directly to computers accessing the server through the client.

With the increasing mobility of the world, users wish that any system (for example, a communication system) could be used in any environment. However, carrying large or heavy devices may be inconvenient and undesirable for users. In addition to that, users, when playing a game on a digital device, wish to have a display as large as possible, whereas in everyday life the digital device having a large display may cause inconvenience.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided is a wearable personal digital (WPD) flexible cloud game, multimedia, communication and computing device, a method for accessing game and multimedia data and performing communications using a WPD flexible cloud game, multimedia, communication and computing device, and a method for facilitating payments using a WPD flexible cloud game, multimedia, communication and computing device. The device comprises a flexible display, a flexible power source, a processor, a memory unit, and a communication circuit. The flexible display and the flexible power source may be connected in a sandwich-like manner and may be folded in a desired configuration or rolled up in a scroll. The processor may be configured to communicate with a game and multimedia server and a communication server over a network to transfer game, multimedia and communication data, and transmit, on a user request, the game, multimedia and communication data to one or more external devices. The memory unit may be configured to store game, multimedia and communication data and instructions to perform certain operations. The communication circuit may be configured to communicate with the network and the one or more external devices.

In some embodiments, the flexible display and the flexible power source may each have a thickness of approximately 0.1 mm to 2.5 mm.

In certain example embodiments, the communication circuit may include a Bluetooth module, a communication port, including a universal serial bus (USB) port, a parallel port, an infrared transceiver port, a radiofrequency transceiver port, and so forth. One or more external devices may include a television set, a set-top box, a computer, a laptop, a smartphone, a WPD device, a digital eyeglass device, and so forth.

Provided also is a method for accessing game and multimedia data and performing communications using a WPD flexible cloud game, multimedia, communication and computing device. In certain embodiments, the method may comprise receiving, by the WPD flexible cloud game, multimedia, communication and computing device, a user request to display the game, multimedia and communication data, communicating with a game and multimedia server and a communication server over a network to transfer game multimedia and communication data, and displaying the game multimedia and communication data on a display of the WPD flexible cloud game, multimedia, communication and computing device.

Provided also is a method for facilitating mobile device payments using a WPD flexible cloud game, multimedia, communication and computing device. To facilitate payments, the WPD flexible cloud game, multimedia, communication and computing device may have data associated with one or more payment cards or accounts of the user stored in the memory or on a data server. To make a payment, the user may request the payment card or account data (i.e., the data associated with the user) to be displayed on the display of the WPD flexible cloud game, multimedia, communication and computing device in the form of a barcode. The barcode may then be scanned by a barcode scanner, and the corresponding payment card or account may be charged.

In further exemplary embodiments, modules, subsystems, or devices can be adapted to perform the recited steps. Other features and exemplary embodiments are described below.

### BRIEF DESCRIPTION OF DRAWINGS

Embodiments are illustrated by way of example and not limitation in the figures of the accompanying drawings, in which like references indicate similar elements and in which:

FIG. 1 illustrates an example network segment for implementing various aspects of methods for accessing game and multimedia data and performing communications using the WPD flexible cloud game, multimedia, communication and computing device.

FIG. 2A is a schematic representation of a general view of a sample WPD flexible cloud game, multimedia, communication and computing device in a folded state, in accordance with an example embodiment.

FIG. 2B is a schematic representation of a general view of a sample WPD flexible cloud game, multimedia, communication and computing device in an unfolded state, in accordance with an example embodiment.

FIG. 3A is a schematic representation of a general view of a sample WPD flexible cloud game, multimedia, communication and computing device, in accordance with an example embodiment.

FIG. 3B is a schematic representation of a general view of a sample WPD flexible cloud game, multimedia, communication and computing device, in accordance with an example embodiment.

FIG. 3C is a schematic representation of a general view of a sample WPD flexible cloud game, multimedia, communication and computing device, in accordance with an example embodiment.

FIG. 4 is a schematic representation of a sample WPD flexible cloud game, multimedia, communication and computing device, in accordance with an example embodiment.

FIG. 5 is a flow chart illustrating a method for accessing game and multimedia data and performing communications using a WPD flexible cloud game, multimedia, communication and computing device, in accordance with certain embodiments.

FIG. 6 is a flow chart illustrating a method for facilitating payments using a WPD flexible cloud game, multimedia, communication and computing device, in accordance with certain embodiments.

FIG. 7 shows a payment performed by the WPD flexible cloud game, multimedia, communication and computing device, in accordance with an example embodiment.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

A WPD flexible cloud game, multimedia, communication and computing device, a method for accessing game and multimedia data and performing communications using a WPD cloud game, multimedia, communication and computing device, and a method for facilitating payments using a WPD flexible cloud game, multimedia, communication and computing device are described herein. The WPD flexible cloud game, multimedia, communication and computing device may enable a user to play games, view multimedia content, perform communications (e.g., making phone calls, writing messages, e-mails, etc.), and access a network (e.g., Internet) in any environment. Thus, the WPD flexible cloud game, multimedia, communication and computing device may serve as a game console, a computer, a mobile phone, and the like.

The WPD flexible cloud game, multimedia, communication and computing device may facilitate payments and data exchange by generating and/or displaying barcodes encoding payment information or other data on a display of the WPD flexible cloud game, multimedia, communication and computing device. Being worn on any part of a human body or clothes due to its flexible configuration, the WPD flexible cloud game, multimedia, communication and computing device may provide for convenient carrying in many situations and environments, such as physical activity, sports, travels, leisure time, and so forth.

A user may store his payment information (i.e., payment account number, payment card, and so forth) on the WPD flexible cloud game, multimedia, communication and computing device. For a payment, the user may request to provide the payment information. The payment information may then be encoded in a barcode and displayed on the display of the WPD flexible cloud game, multimedia, communication and computing device for scanning by a barcode reader, a smart phone, another WPD flexible cloud game, multimedia, communication and computing device, and so forth. The barcode may include various types of optical codes, such as a Unified Product Code (UPC) represented as a barcode and/or an alphanumeric string, an Electronic Product Code (EPC) encoded as a printed barcode or encoded on a Radio Frequency Identification (RFID) tag, or any other variations of linear barcode, two-dimensional or matrix barcodes, a snap tag code, a QR code, alphanumeric string (e.g., 8-bit, 16-bit, 32-bit string), electronically encoded codes (e.g., 96-bit strings), and so forth.

Another possible use of the WPD flexible cloud game, multimedia, communication and computing device may be receiving information, such as discount cards, membership cards, tickets, boarding passes, an identification (ID) card, a driver's license, a permanent resident card, and so forth. The information may be presented as, or related to, barcodes, encoded in barcodes, and so forth. For example, the user may store a cinema ticket in a form of a barcode on the WPD flexible cloud game, multimedia, communication and computing device and produce the ticket by displaying it on the display of the WPD flexible cloud game, multimedia, communication and computing device.

The information may be received wirelessly or by wire, by capturing an image of a discount card, ticket, boarding pass, advertising material, and so forth. Such information may be stored on the WPD flexible cloud game, multimedia, communication and computing device for future usage (producing a ticket or a discount card), or the information may be retrieved from a barcode to be shown on the display of the WPD flexible cloud game, multimedia, communication and computing device. For example, the user may scan a barcode presented on an advertising leaflet to get additional information encoded in the barcode. The barcode may be resolved by the WPD flexible cloud game, multimedia, communication and computing device, and the information encoded in the barcode may be shown on the display of the WPD flexible cloud game, multimedia, communication and computing device for the user. In some case, the information encoded in the barcode may include a link to a web-resource. Then, after resolving the barcode, the WPD flexible cloud game, multimedia, communication and computing device may access the web-resource and display the web-resource to the user.

In addition to that, the information retrieved from a scanned barcode may be a payment request. The payment request may include payment related information, such as receiving account, bank of the receiver, and so forth. An amount to be paid may be encoded in the barcode or provided by the paying user. Thus, users of the WPD flexible cloud game, multimedia, communication and computing devices may make payments to a merchant by scanning a barcode that encodes a payment request and approving the payment request retrieved from the scanned barcode. Additionally, users of the WPD flexible cloud game, multimedia, communication and computing devices may make payments between themselves using the WPD flexible cloud game, multimedia, communication and computing devices, with the WPD device of the payment receiver generating and displaying corresponding barcodes, and the WPD flexible cloud game, multimedia, communication and computing device of the payer scanning and processing the barcode.

The WPD flexible cloud game, multimedia, communication and computing device may comprise a flexible display, a flexible power source, a processor, a memory, and a communication circuit. The flexible display and the flexible power source may be connected in a sandwich-like manner. The flexible configuration of the display and the power source may allow the WPD flexible cloud game, multimedia, communication and computing device to fold over 180 degrees like a sheet of paper or to roll up into a scroll. The WPD flexible cloud game, multimedia, communication and computing device may be folded at least 110,000 times without creasing. The WPD flexible cloud game, multimedia, communication and computing device may be folded in half; in three parts, where two side parts cover, from sides, a central part of the device; or in three parts, where all three parts are of the same width and a first side part covers a central part and a second side part covers the first side part. The thickness of the flexible display and the flexible power source may be approximately 0.1 mm to 2.5 mm.

Whereas conventional mobile phones normally have thickness of about 7 to 9 mm (e.g., iPhone 5-7.6 mm, Galaxy 3-8.6 mm), the flexible display and the flexible power source screen, each having a thickness of approximately 0.1 to 2.5 mm, allow producing a WPD flexible cloud, game, multimedia, communication and computing device having a thickness of less than 5 mm.

The flexible configuration of the WPD flexible cloud game, multimedia, communication and computing device may allow a user to fold the WPD flexible cloud game, multimedia, communication and computing device when the user is not using the device and unfold and employ the device when desired. For example, when ready to play a game, view multimedia content or perform communication, the user may unfold the WPD flexible cloud game, multimedia, communication and computing device. In an unfolded state, the device may communicate with a game and multimedia server and a communication server over a network and transfer game, multimedia and communication data to/from the game and multimedia server and the communication server. In some embodiments, the device may communicate with a network to provide the user with access to the network. Thus, the user may play cloud games, view multimedia content, and/or perform communications on demand or access other content in any environment.

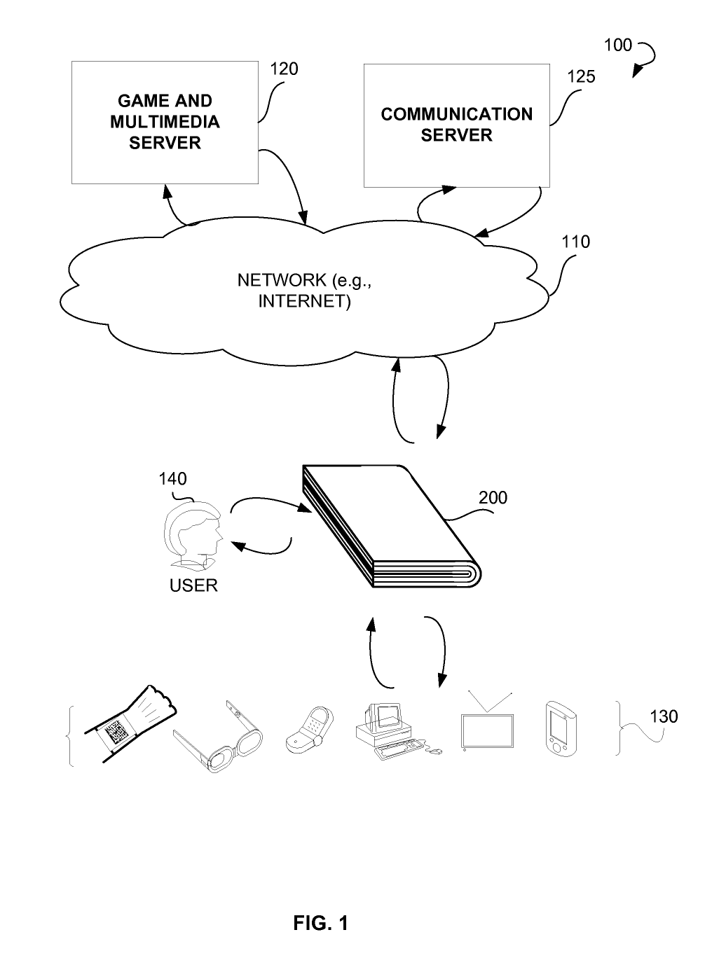

To enable device connection with the one or more external devices, the device may have the communication circuit. The communication circuit may include a Bluetooth module, a communication port, including a USB port, a parallel port, an infrared transceiver port, a radiofrequency transceiver port, and so forth. The device may have Internet connectivity using cellular networks (e.g., 3G, 4G) as well as Wi-Fi and other types of networks. Some additional examples of such networks are described below with reference to FIG. 1. Wireless communication may be used to transmit and receive the game, multimedia and communication data to/from the game and multimedia server and the communication server and one or more external devices, transmit user command data, and so forth. Overall, various data may be exchanged between the device and the game and multimedia server and the communication server as well as other servers during operations of the method.

Before describing various methods and associated operations, a brief description of a computer network is described. Specifically, FIG. 1 illustrates an example network segment for implementing various aspects of methods for accessing game and multimedia data and performing communications using the WPD flexible cloud game, multimedia, communication and computing device. As shown, one or more external devices 130 may communicate with a WPD flexible cloud game, multimedia, communication and computing device 200. The device 200 may communicate with a game and multimedia server 120 and/or a communication server 125 via network 110. Network 110 may be also used for communication among various components of a system for accessing game and multimedia data and performing communications using the device 200. The game and multimedia data may include cloud game data, video on demand data, network data, and so forth. The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB connection or other wired or wireless, digital or analog interface or connection, mesh or Digi® networking. The network 110 may include any suitable number and type of devices (e.g., routers and switches) for forwarding commands, content, and/or web object requests from each client to the online community application and responses back to the clients. The device 200 may communicate with the GPS satellite via the network 110 to exchange data on a geographical location of the device 200. Additionally, the device 200 may communicate with mobile network operators using a mobile base station.

The methods described herein may also be practiced in a wide variety of network environments (represented by network 110) including, for example, TCP/IP-based networks, telecommunications networks, wireless networks, etc. In addition, the computer program instructions may be stored in any type of computer-readable media. The program may be executed according to a variety of computing models including a client/server model, a peer-to-peer model, on a stand-alone computing device, or according to a distributed computing model in which various functionalities described herein may be effected or employed at different locations.

The device 200 may connect to the one or more external devices 130. The external devices 130 may include a television set, a set-top box, a computer, a laptop, a smart phone, a WPD device, a digital glass device, and so forth. The device 200 may connect to the one or more external devices 130 wirelessly or by wires using various connections such as a USB port, a parallel port, an infrared transceiver port, a radiofrequency transceiver port, and so forth. The device 200 may be controlled using one or several external devices 130. For example, a user may run an application on a smart phone and control the operation of the device 200 via the smart phone.

For the purposes of communication, the device 200 may be compatible with one or more of the following network standards: GSM, CDMA, LTE, IMS, Universal Mobile Telecommunication System (UMTS), 4G, 5G, 6G and upper, RFID, and so forth.

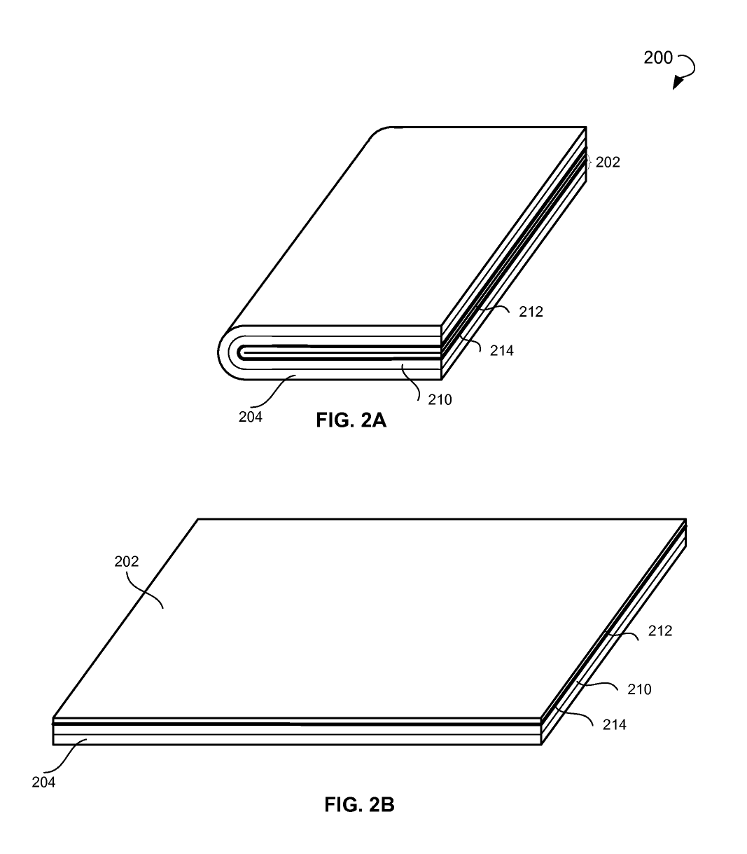

FIG. 2A schematically shows a general view of a device 200 in a folded state, in accordance with certain embodiments. Specifically, the device 200 may comprise a flexible display 202, a flexible power source 204, a processor (not shown), a memory unit (not shown), and a communication circuit (not shown).

The flexible display 202 may comprise at least three layers: at least one displaying layer 210, at least one protective layer 212 covering the at least one displaying layer 210, and a flexible layer 214 disposed between the at least one displaying layer 210 and the at least one protective layer 212. The displaying layer 210 may include a light-emitting diode (LED) matrix configurable to fold in half or in any other desired configuration. In some embodiments, the displaying layer 210 may include an organic light-emitting diode (OLED) matrix. The protective layer 212 may include any hard material resistant against strikes, scratches, and any other impacts. The protective layer 212 may include glass, in particular flexible glass or flexible organic glass, thereby allowing the protective layer 212 to be folded in a desired configuration. The protective layer 212 may act as a touchscreen display configured to enable user interaction with the device 200 through touch. The flexible layer 214 may include a layer of silicone rubber, which is an elastic material and allows folding in any configuration. The three layers of the flexible display 202 may be bonded to each other resulting in a sandwich-like structure. The flexible display 202 may have a thickness of approximately 0.1 mm to 2.5 mm.

The display 202 of the device 200 may include a touchscreen display, so that a user 140 may interface with the device 200 using the touchscreen display. The touchscreen display may sense a user command and transmit the sensed user command to the device 200. The device may transmit the received user commands to the game and multimedia server 120 and the communication server 125 over the network 110 and receive response data from the game and multimedia server 120 and the communication server 125. The display 202 may be communicatively coupled to the processor and configured to graphically display one or more of the following: the payment data, the personal data, the barcode information, one or more barcodes (for example, payment barcodes), and the time data. Displaying a barcode may involve processing information to encode into a barcode image. A barcode may encode and store the payment data, the personal data, group of payment data, credit card data, debit card data, gift card data, prepaid card data, bank checking account data, digital cash data, and other data. The local processing may be performed by the processor using various software applications installed on the device 200.

In some embodiments, the display 202 may comprise sections including an electronic paper (also called “electronic ink”) display. To save power of the power source 204, at least part of the data may be displayed on the electronic paper display. Furthermore, the electronic paper display is known to have better visibility under sunlight than, for example, an LCD display.

The flexible power source 204 may include a paper battery. The paper battery may be an electric battery of approximately 0.1 mm to 2.5 mm thickness, in which a spacer formed largely of cellulose is used, and the cellulose consists mostly of paper. The paper battery may comprise nanoscale structures to act as high surface-area electrodes to improve the conduction of electricity. The nanoscale structures may include carbon nanotubes embedded into the spacer. Furthermore, the paper battery may comprise an electrolyte embedded into the spacer. The paper battery may be flexible, thus being able to be folded or to be rolled up in a scroll.

The processor may be configured to communicate with a game and multimedia server 120 and a communication server 125 over a network 110 to transfer game, multimedia and communication data, and to transmit, on a user request, the game, multimedia and communication data to one or more external devices 130. The processor may include various types including microcontrollers and microprocessors, such as programmable devices (e.g., CPLDs and FPGAs) and unprogrammable devices, such as gate array ASICs or general purpose microprocessors. Furthermore, the processor may be configured to generate, based on payment data, personal data, or other data, one or more barcodes encoding the payment data, the personal data, or the other data; and provide, upon a user's request, one or more of the following: the one or more barcodes, the payment data, the personal data, or the other data. In some embodiments, the device 200 may be further configured to download, install, and run applications, receive and send text, video, and multimedia data, and perform other operations.

The memory unit, such as tangible computer readable memory, may store the game, multimedia and communication data and/or instructions to perform one or more operations. The communication circuit may be communicatively coupled to the processor and configured to communicate with the network 110 and the one or more external devices. In various embodiments, the communication circuit may include a Bluetooth module, a communication port, including a USB port, a parallel port, an infrared transceiver port, a radiofrequency transceiver port, and so forth.

In some embodiments, the device 200 may comprise a housing (not shown). The housing may enclose the flexible display 202, the flexible power source, the processor, the memory unit, and the communication circuit.

In some embodiments, the device 200 may comprise a USB port (not shown). The USB port may be used to connect the device 200 to an external device 130.

FIG. 2B schematically shows a general view of a device 200 in an unfolded state, in accordance with certain embodiments. The device 200 is shown ready-to-use when a user 140 may directly interface with the device 200. As shown on FIG. 2B, the flexible power source 204 may be disposed in the lower part of the device 200 and the flexible display 202 may be disposed on the flexible power source 204.

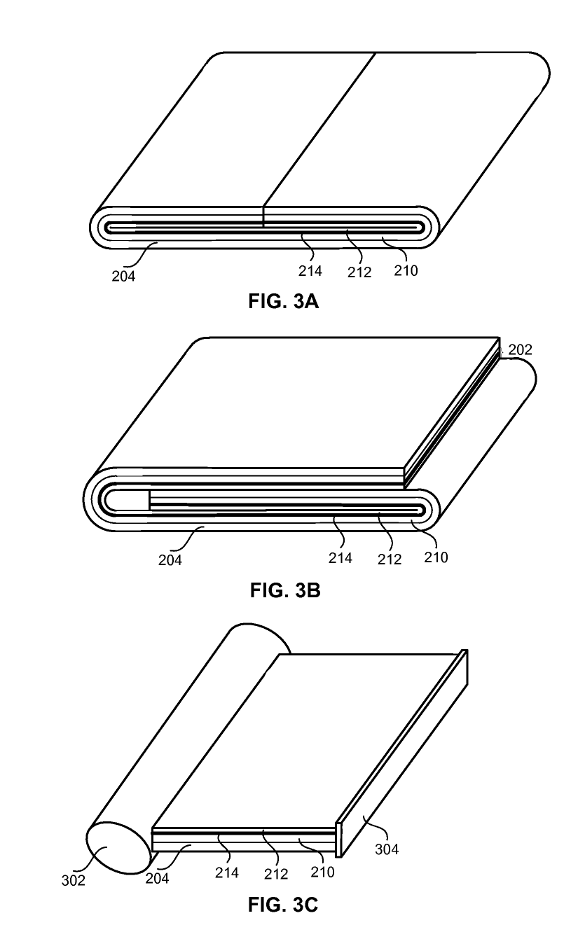

FIG. 3A schematically shows a general view of a sample device 200, in accordance with an example embodiment. The device 200 may comprise two side parts and a central part and may be folded in three parts: two side parts may cover a central part of the device 200 from sides. In this embodiment, the central part of the device may be approximately two times longer than each of the side parts.

FIG. 3B schematically shows another sample device 200, in accordance with an example embodiment. In this embodiment, the device 200 may be folded in three parts. The device may comprise two side parts and a central part, and all three parts may be of approximately the same length. The first side part may be folded to cover the central part, and second side part may be folded to cover the first side part of the device 200.

FIG. 3C schematically shows another sample device 200, in accordance with an example embodiment. In this embodiment, the device 200 may be rolled up in a scroll. The device 200 may be rolled up into a tube case 302. Rolling up the device into the case 302 may be activated by pushing a button (not shown) on the case 302 or by pushing the side of the device 200 in the direction of the case 302. The device 200 may comprise a limiter 304, which will not allow the device 200 to roll up completely into the case 302.

In some embodiments, the device 200 may comprise a sound generating unit (not shown). The sound generating unit may emit sounds corresponding to the game, multimedia and communication data or any data received by the device 200 or stored on the device 200.

In some embodiments, the device 200 may comprise a camera (not shown). The camera may be communicatively coupled to the processor and configured to scan a barcode. Scanning a barcode may involve capturing an image of the barcode using the camera. The scanned barcode may be processed by the processor to retrieve the barcode information. Using the camera of the device 200, the user may capture pictures of various cards, tickets, or coupons. Such pictures, stored in the memory of the device 200, may comprise data related to captured cards, tickets, or coupons. Additionally, the camera may be configured to capture photos and record video.

In some embodiments, the user may give a command to generate and display a barcode encoding payment data to make a payment in a retail environment. For example, the user may scan one or more product barcodes using the device 200 and, based on the data retrieved from the product barcodes, cause the device 200 to generate a payment barcode to purchase the products whose barcodes were scanned. Thus, the device 200 may enable self-checkout by scanning product barcodes and generating a barcode encoding payment data of the user (a payment barcode) that may be provided for scanning by the user. The barcodes displayed by the device 200 may be scannable by a barcode scanner, a checkout scanner, a check-in scanner, an external device, another WPD device, and so forth.

In some example embodiments, once a product barcode is scanned or a product image is captured, the device 200 may retrieve data concerning products similar to the scanned products and display the retrieved data associated with the similar products currently available from the providers of the similar products. Furthermore, upon user request, the device may display only the products having a lower price than the price of the scanned product.

In some example embodiments, the user may listen to the music stored in the memory unit of the device 200, for example, using a wireless head set or an earplug. The device 200 may be configured to analyze music records stored in the memory unit, communicate, over a network, with music providers, display the music records available from the music providers, the displayed music records being similar to the music records stored in the memory unit of the device 200.

In some example embodiments, the device 200 may be configured to communicate with a gambling cloud service or a gaming cloud service. The device 200 may exchange gambling or gaming data with a cloud service, thus allowing the user to gamble or play games using the cloud service. Based upon user request, the device 200 may transfer payments related to gambling or gaming. Payments may be performed using payment data of the user associated with an account of the user in the cloud service, using payment data of the user stored in the device 200, and/or using the swipe card reader to read payment card data.

Additionally, in some example embodiments, one or more solar cells may be disposed on and electrically connected to the flexible power source 204. The solar cells may be configured to charge the flexible power source 204. In other embodiments, the flexible power source 204 may be configured to charge using natural movement vibrations, for example, vibrations caused by walking, jogging, exercise, and so forth. In yet other embodiments, the flexible power source 204 may be configured to charge wirelessly using an external wireless charger accessory.

In some embodiments, the device 200 may synchronize with the one or more external devices in real time to exchange data.

The device 200 may further comprise an operating system executing on the processor. The operating system may include Android, iOS, Firefox OS, and so forth.

In some example embodiments, the device 200 may further comprise a microphone (not shown). The microphone may be configured to sense voice data and transmit the voice data to the processor for processing. The voice data may include a voice command, a voice memo, a voice message, and so forth. Thus, a user may give voice commands to the device 200, for example, when jogging, record voice memos, send voice messages, and so forth.

Additionally, the device 200 may include a swipe card reader (not shown) to read payment card data. The swipe card reader may be located on either side of the device 200, either vertically or horizontally.

In some embodiments, the device 200 may utilize one or more sensors to sense biometric parameters, such as blood pressure, pulse, heart rate, arterial pressure of the user, quality of sleep. The one or more sensors may include one or more of the following: a heartbeat rate meter, glucose level meter, pressure sensor, body temperature meter, environment temperature meter, one lead EGO, and so forth. The biometric parameters sensed by the one or more sensors may be shown on the display 202, stored in the memory, and/or processed by the processor to receive historical or averaged biometric data. In various embodiments, the one or more sensors may be located in various locations such as to ensure a secure contact with the user skin or to avoid skin contact depending on the parameter sensed by a sensor.

In some embodiments, access to the device 200 may be protected by a password, a Personal Identification Number (PIN) code, biometric authorization, and so forth. Biometric authorization may be performed using one or more biometric sensors and may include fingerprint scanning, palm scanning, face scanning, retina scanning, and so forth. In some embodiments, fingerprint scanning may be performed using a fingerprint reader integrated in the device 200 or detachably connected to the device. The scanned fingerprint may be matched to one or more approved fingerprints stored in the memory of the device 200. The access to the device may be granted if the scanned fingerprint matches one of the stored fingerprints, otherwise access may be denied.

In some embodiments, the device 200 may include one or more accelerometers (not shown) to track activity of the user for purposes of monitoring energy expenditures or calories burned, evaluating sleep quality, calculating breaths per minute, snoring breaks, steps and/or distance walked, and so forth. The one or more accelerometers may also be used to control game movements.

In some embodiments, the device 200 may be configured to track a geographical location of the one or more external devices in real time, and provide communication capabilities using an embedded emergency button configured to give a medical alert signal, a request for help signal, or another informational signal.

In certain example embodiments, the device 200 may sense and track position of the user to control snoring of the user by means of one or more accelerometers and/or biometric sensors.

In further embodiments, the device 200 may be used to record, send, receive, and review texts, images, video, audio, photo, multi-media, and other data.

The device 200 may further include a GPS module (not shown) configured to track geographical location of the device. Such information may be applied for spatial and positional awareness tracking, monitoring position of a child, a senior, or a patient. In some embodiments, the device 200 may connect to one or more external devices (for example, other WPD devices) and send data on own geographical location and receive data on geographical location of the one or more external devices. Thus, users may track geographical location of each other.

Additionally, the device 200 may include an alert unit (not shown) configured to alert the user about one or more events by vibration and/or sound. For example, the device 200 notify the user about incoming messages and/or data, remind to take pills, alert the time when blood pressure and glucose level of the user are high, remind to make exercises, serve as an alarm clock, and so forth. Furthermore, the vibration and sound of the alert unit may be used by a guide tool and exercise learning service.

In some embodiments, the device 200 may further comprise one or more subscriber identification module (SIM) cards that can be used for connectivity and other purposes. Also, the device 200 may include one or more additional memory units to expand storage capacity of the device. In some embodiments, the device 200 may offer options for expandable memory by including a physical interface configured to receive memory devices external to the device. In some embodiments, the physical interface may include an external microSecureDigital (microSD) slot. Aside from microSD slot, the device 200 may provide for adding an external memory device using other interfaces such as, for example, MultiMediaCard (MMC), SD, miniSD, Firewire, and others.

Moreover, a two way radio transceiver (not shown) may be included in the device 200 for communication and personal emergency response as well as entertainment use.

To provide for giving an alarm signal in case of danger or when help is needed, the device 200 may comprise an emergency button. The emergency button may be used by children, seniors, patients, and so forth. The alarm signal may comprise a signal sent to an external device connected with the device 200, a sound signal generated by the device 200, a light signal, another signal, or a combination of them.

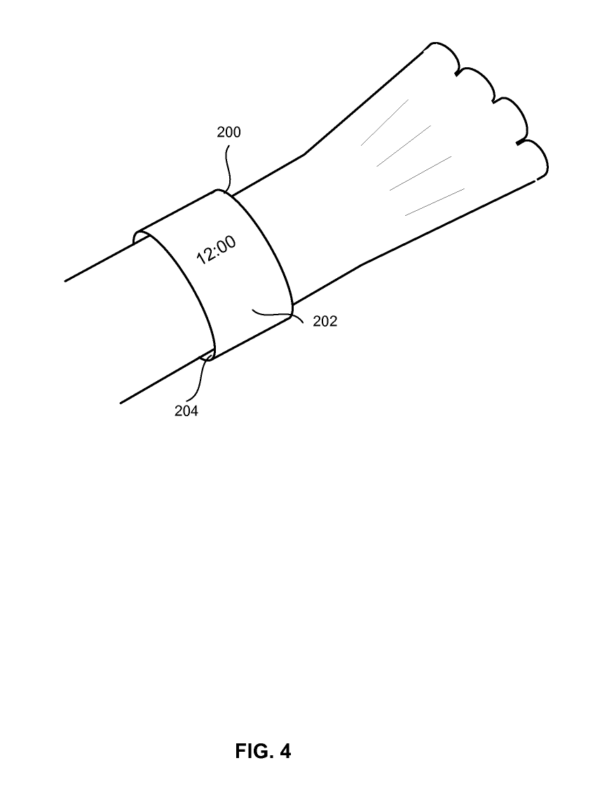

FIG. 4 shows another sample device 200, in accordance with an example embodiment. In this embodiment, the device 200 may be a flexible personal computer wearable around a user's wrist. The device 200 may include a flexible display 202 and a flexible power source 204 connected in a sandwich-like manner. The display 202 may comprise: a displaying layer, e.g. a LED matrix being configurable to roll up, a protective layer, e.g. a flexible glass, covering the displaying layer, and a flexible layer, e.g. silicone rubber, disposed between the displaying layer and the protective layer. The display 202 may include a touchscreen display configured to enable user interaction with the device 200 through touch. The power source 204 may include a paper battery. The paper battery may be flexible, thus being able to roll up around the user's wrist. The device 200 may comprise a processor, e.g. an integrated circuit (IC) also referred to as a chip. The processor may be flexible and configurable to roll up. The processor may be disposed between the display 202 and the power source 204 or may be embedded into the display 202 or the power source 204. The thickness of the device 200 may be approximately 0.2 mm to 5 mm.

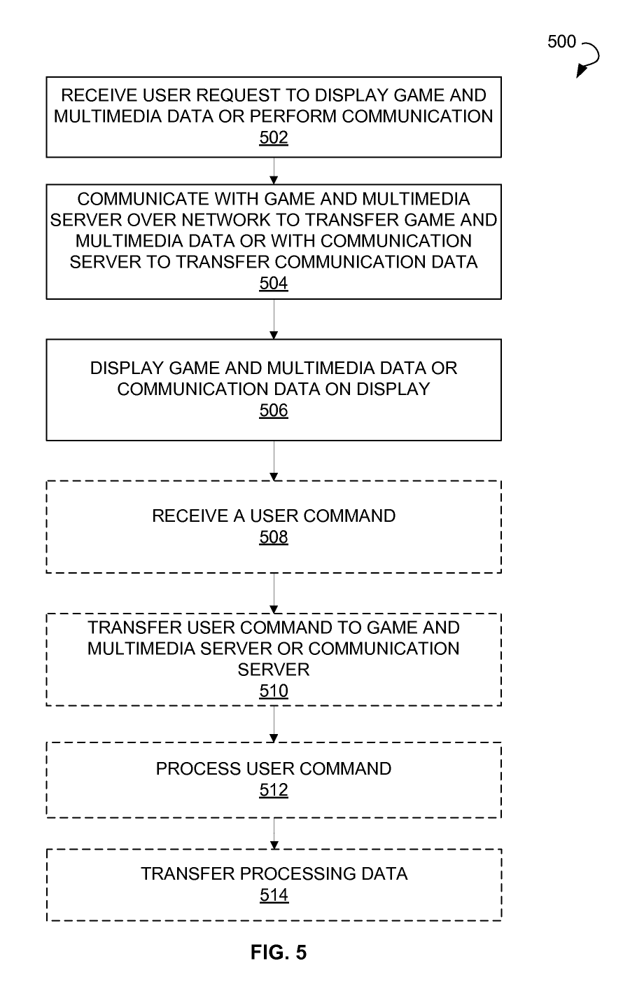

FIG. 5 is a flow chart illustrating a method 500 a method for accessing game and multimedia data and performing communications using a device 200, in accordance with certain embodiments. Method 500 may start with a game and multimedia server or a communication server receiving a user request to display a game, view multimedia content or perform communication at operation 502. The user request may be received from the device 200. At operation 504, the device 200 may communicate with the game and multimedia server over a network to transfer the game and multimedia data, or with the communication server to transfer the communication data based on the user request. For example, a user may request to play a game, view multimedia content, perform a phone call, and so forth. The transferred game and multimedia data or the communication data may be displayed on a display at operation 506.

In some embodiments, the user may give commands during a game or when performing communication, for example, by means of the touchscreen of the device 200. Method 500 may optionally proceed with receiving a command from a user at operation 508. At optional operation 510, the user command may be transferred to the game and multimedia server or the communication server. The game and multimedia server or the communication server may process the received user command at optional operation 512, and transfer the processing data to the device 200 at optional operation 514.

In some embodiments, method 400 may optionally proceed with receiving, by the processor of the device 200, incoming communication data. The incoming communication data may include incoming calls, text messages, e-mails, and so forth. The user may be notified about the incoming communication data, for example, by displaying a notification on the display or playing a sound generated by the sound generating device. The user may give a command in response to the incoming communication data. The processor of the device 200 may receive and process the command of the user. After the command is processed by the processor, the incoming communication data may be displayed on the display of the device 200. In certain embodiments, a sound corresponding to the incoming communication data may be generated by a sound generating unit.

In some embodiments, the game and multimedia data or the communication data may be transferred, by the processor of the device 200, to a digital eyeglass device, a television set, a set-top box, a computer, a laptop, a smartphone, a wearable personal digital device, and any other external device.

In certain embodiments, the network for communication between the device 200 with external devices may include GSM, CDMA, LTE, IMS, UMTS, RFID, WiFi, 4G, 5G, 6G and upper.

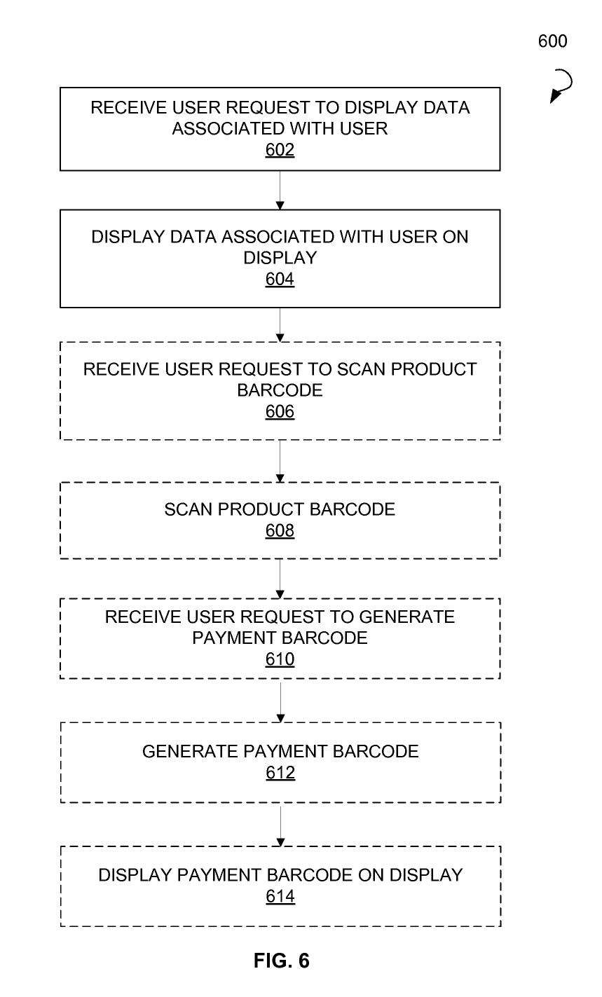

FIG. 6 is a flow chart illustrating a method for facilitating payments using a device 200. Method 600 may start with receiving a user request to display data associated with a user at operation 602. The data to be displayed may be stored in a memory unit of the device 200 or on a data server; in the latter case, the data to be displayed may be transmitted from the data server to the device 200. The user may send the request to display data using the touchscreen.

Based on the user request, the data associated with the user may be displayed on a display of the device 200 at operation 604. The data may be displayed in the form of a barcode scannable by a checkout scanner, check-in scanner, a mobile device, a camera, another WPD flexible cloud game, multimedia, communication and computing device, and so forth. The barcode may be generated by the device 200 or stored in the memory of the device 200.

The data may include payment data, personal data, time data, or health and activity data associated with the user. The payment data may include a barcode encoding information related to a payment account of the user, payment amount, bank of the payment account, and so forth. Thus, the user may make a payment by showing a barcode encoding payment data that may be scanned, for example, by a barcode scanner instead of a payment card in a retail environment. Personal data associated with the user may include a ticket, a boarding pass, a coupon, a discount card, a membership card, and the like. The user may produce such data on a display of the device 200 to get a discount, activate a coupon, get access to a sports club, and so forth.

In some embodiments, the barcode displayed by the device 200 (e.g., QR code) may encode electronic key data to enable entry in locked premises. Such barcodes may be used to enter home rooms, office rooms, hotel rooms, and so forth. To enter a locked room, the user may provide a key barcode displayed on a display of the device 200 to be scanned by a web-camera of an access control system. The barcode scanned by the web-camera may be transmitted to the access control system to retrieve the key encoded by the barcode and find the key in a database of approved keys. If the key is found in the database, the access control system may grant the user access to the room and unlock the door. Thus, the device 200 may store electronic keys for various premises, cars, storages, and so forth allowing the user to avoid carrying a chain of keys to meet any situation.

Referring back to FIG. 6, method 600 may optionally proceed with receiving from the user a request to scan a product barcode at operation 606. At optional operation 608, the product barcode may be scanned by the camera of the device 200. At optional operation 610, the processor of the device 200 may receive a user request to generate a payment barcode based on the data retrieved from the product barcode. The processor may generate the payment barcode at optional operation 612. The payment barcode may be displayed on the display of the device 200 at optional operation 614.

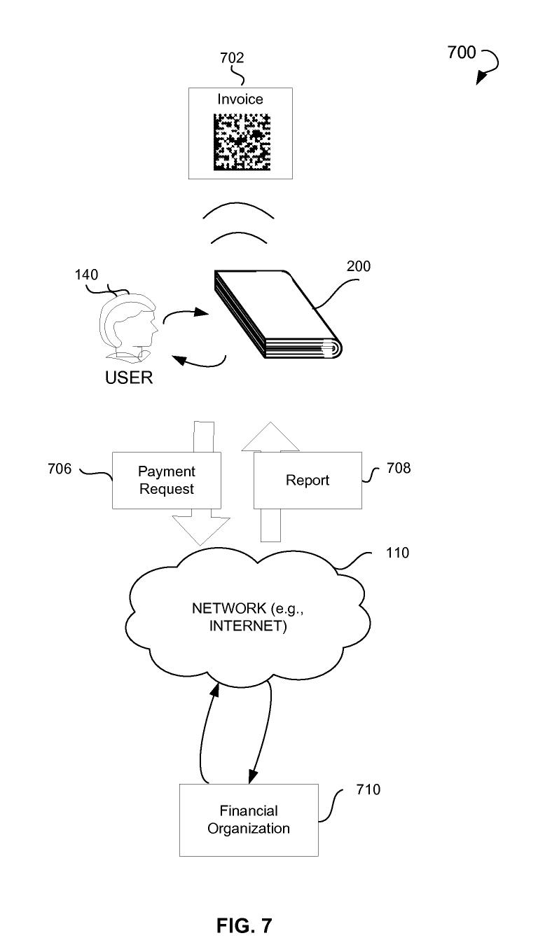

FIG. 7 shows payment 700 using a payment card, in accordance to some embodiments. A user 140 may receive invoice data by scanning a barcode of an invoice 702 using a camera of the device 200. The invoice 702 may encode payment request information, such as receiving account, amount to be paid, and so forth. However, in some embodiments, the amount to be paid may be provided by the user.

To pay the invoice 702, the user 140 may choose to pay electronically using the payment data stored on the device 200 or by a payment card. To pay using the payment card, the user may swipe the payment card via the swipe card reader of the device 200. Upon swiping the payment card, the device 200 may receive payment data associated with the payment card and generate a payment request 706 based on the payment data associated with the payment card and the payment request information of the invoice. Then the 200 may send the payment request 706 to a financial organization 710 associated with the payment data related to the payment card.

The financial organization 710 may process the payment request 706 and either accept the payment or deny it. Then, a report 708 may be generated and sent to the device 200 via the network 110. The report 708 may inform user whether the payment succeeded or was denied.

Thus, various systems and methods for accessing game and multimedia data and performing communications using the WPD flexible cloud game, multimedia, communication and computing device have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A wearable personal digital flexible cloud game, multimedia, communication and computing device, the device comprising:
a flexible display comprising:
at least one displaying layer;
at least one protective layer covering the at least one displaying layer; and
a flexible layer disposed between the at least one displaying layer and the at least one protective layer;
a flexible power source underlying the display;
a processor configured to:
communicate with a game and multimedia server and a communication server over a network to transfer and receive game, multimedia and communication data;
transmit, on a user request, the game, multimedia and communication data to one or more external devices;
a memory unit communicatively coupled to the processor; and
a communication circuit communicatively coupled to the processor and configured to communicate with the network and the one or more external devices, a bearer worn under, with or on top of clothing for applications of sensory integration, behavioral modeling, mobile phones, smart phones, health care monitoring systems, electronics textiles, augmented reality, and pattern recognition.

2. The device of claim 1, the device further comprising a housing adapted to enclose the display, the power source, the processor, the memory unit, and the communication circuit.

3. The device of claim 1, wherein the flexible layer includes a silicone rubber.

4. The device of claim 1, wherein the protective layer includes glass.

5. The device of claim 4, wherein the glass includes flexible glass and flexible organic glass.

6. The device of claim 1, wherein the display includes a touchscreen display configured to enable user interaction with the device through touch.

7. The device of claim 1, wherein the displaying layer includes a light-emitting diode (LED) matrix or plastic display.

8. The device of claim 1, wherein the flexible display further comprises an electronic paper display, wherein the electronic paper display displays the game, multimedia and communication data.

9. The device of claim 1, wherein the power source includes a paper battery.

10. The device of claim 9, wherein the paper battery includes one or more carbon nanotubes, an electrolyte, and a spacer disposed between the carbon nanotubes and the electrolyte, the spacer including cellulose, wherein the carbon nanotubes and the electrolyte are incorporated into the spacer.

11. The device of claim 1, wherein a thickness of the display is approximately 0.1 mm to 2.5 mm.

12. The device of claim 1, wherein a thickness of the power source is approximately 0.1 mm to 2.5 mm.

13. The device of claim 1, wherein a thickness of the device is approximately 0.2 mm to 5 mm.

14. The device of claim 1, wherein the communication circuit includes one or more of the following: a Bluetooth module, a communication port, including a universal serial bus (USB) port, a parallel port, an infrared transceiver port, and a radiofrequency transceiver port.

15. The device of claim 1, wherein the one or more external devices include a television set, a set-top box, a computer, a laptop, a smartphone, a wearable personal digital device, and a digital eyeglass device.

15. The device of claim 15, wherein the WPD connects to the one or more external devices using one or more of the following: a Bluetooth module, a communication port, including a universal serial bus (USB) port, a parallel port, an infrared transceiver port, and a radiofrequency transceiver port.

17. The device of claim 1, wherein the device is compatible with one or more of the following network standards: GSM, CDMA, LTE, IMS, Universal Mobile Telecommunication System (UMTS), RFID, WiFi, 4G, 5G, 6G and upper.

18. The device of claim 1, the device further comprising a sound generating unit.

19. The device of claim 1, wherein the processor is further configured to:
generate, based on payment data, personal data, or other data, one or more barcodes encoding the payment data, the personal data, or the other data;
provide, on a user request, one or more of the following: the one or more barcodes, the payment data, the personal data, or the other data.

20. The device of claim 1, the device further comprising a camera communicatively coupled to the processor, the camera being configured to scan a barcode, the scanning being processed by the processor to retrieve the barcode information and enable self-checkout.

21. The device of claim 20, wherein the barcode scanned by the camera includes a link to a web-resource, a payment request, advertising information, and other information.

22. The device of claim 20, wherein the one or more barcodes include a linear dimensional code, a two-dimensional code, a snap tag code, a QR code, and other machine readable code.

23. The device of claim 20, wherein the one or more barcodes encode one or more of the following: payment data, personal data, group of payment data, credit card data, debit card data, gift card data, prepaid card data, bank checking account data, digital cash data, and the other data.

24. The device of claim 1, further comprising an operating system executing on the processor, the operating system including Android, iOS, Firefox OS, and other operating systems.

25. The device of claim 1, the device further comprising a microphone configured to:
sense voice data, the voice data including a voice command, a voice memo, and a voice message; and
transmit the voice data to the processor.

26. The device of claim 1, the device further comprising a swipe card reader to read payment cards data.

27. The device of claim 1, wherein the device is configurable to fold over 180 degrees or to roll up into a scroll.

28. The device of claim 1, wherein the device is controlled by one or more external devices via an application running on the one or more external devices.

29. The device of claim 1, wherein the flexible power source comprises one or more solar cells configured to charge the device.

30. The device of claim 1, wherein the flexible power source charges using natural movement vibrations.

31. The device of claim 1, wherein the flexible power source charges wirelessly using a wireless charger accessory.

32. The device of claim 1, further comprising one or more biometric sensors to sense biometric parameters of the user, the biometric parameters being stored to the memory and processed by the processor to receive historical biometric data.

33. The device of claim 32, wherein the one or more biometric sensors include sensors for measuring one or more of the following: a blood pressure, a pulse, a heart rate, a glucose level, a body temperature, an environment temperature, and arterial properties, the measuring shown on the display.

34. The device of claim 32, wherein access to the device is controlled by one or more of the following: a password, a Personal Identification Number (PIN) code, and biometric authorization, the biometric authorization including fingerprint scanning, palm scanning, face scanning, and retina scanning, wherein the scanning is performed using the one or more biometric sensors.

35. The device of claim 34, further comprising a fingerprint reader configured to scan a fingerprint, the scanned fingerprint being matched to one or more approved fingerprints, wherein the access to the device is granted based on the matching.

36. The device of claim 1, wherein the device synchronizes with the one or more external devices in real time, tracks a geographical location of the one or more external devices in real time, and provides communication capabilities using an embedded emergency button configured to give a medical alert signal, a request for help signal, or another informational signal.

37. The device of claim 1, further comprising one or more accelerometers to track activity of the user and to control game movements, wherein the activity of the user including calories burned, sleep quality, breaths per minute, snoring breaks, steps walked, and distance walked.

38. The device of claim 37, wherein the device controls snoring by sensing a position of the user using the one or more accelerometers.

39. The device of claim 1, wherein the processor is further configured to download applications, receive and send text, video, multimedia data.

40. The device of claim 1, the device further comprising:
a GPS module configured to track geographical location of the device;
an alert unit configured to alert the user about one or more events by one or more of the following: vibration and sound;
one or more subscriber identification module (SIM) cards;
one or more additional memory units;
a physical interface configured to receive memory devices external to the device, wherein the physical interface includes a microSecureDigital (microSD) slot;
a two-way radio transceiver for communication purposes; and
an emergency button configured to send an alarm signal.

41. The device of claim 1, wherein the vibration and sound of the alert unit may be used by a guide tool and an exercise learning service.

42. The device of claim 1, wherein the device is configured to analyze one or more music records stored in the memory unit, communicate, over a network, with one or more music providers, and display data about music records suggested by the music providers for sale, wherein the displayed music records being similar to the music records stored in the memory unit of the device.

43. The device of claim 1, wherein the device may be configured to communicate with a gambling cloud service or a gaming cloud service, exchange gambling or gaming data with the gambling cloud service or the gaming cloud service, and, based on a user request, transfer payments related to gambling or gaming using payment data of the user associated with an account of the user in the cloud service, using payment data of the user stored in the device 200, and/or using the swipe card reader to read payment card data.

44. A method for accessing game and multimedia data and performing communications using a wearable personal digital flexible cloud game, multimedia, communication, and computing device, the wearable personal digital flexible cloud game, multimedia, communication and computing device comprising the wearable personal digital flexible cloud game and communication device of claim 1, and the method comprising:
receiving a user request to display the game and multimedia data or perform communication;
communicating, over a network, with a game and multimedia server to transfer game and multimedia data or a communication server to transfer communication data; and
displaying the game and multimedia data or the communication data on a display of the wearable personal digital flexible cloud game, multimedia, communication and computing device.

45. The method of claim 44, the method further comprising:
receiving, by a processor of the wearable personal digital flexible cloud game, multimedia, communication and computing device, a user command;
transferring the user command to the game and multimedia server;
processing the user command; and
transferring game and multimedia data related to the processing to the wearable personal digital flexible cloud game, multimedia, communication and computing device.

46. The method of claim 44, the method further comprising:
receiving, by a processor of the wearable personal digital flexible cloud game, multimedia, communication and computing device, a user command;
transferring the user command to the communication server;
processing the user command; and
transferring communication data related to the processing to the wearable personal digital flexible cloud game, multimedia, communication and computing device.

47. The method of claim 46, the method further comprising:
receiving, by the processor of the wearable personal digital flexible cloud game, multimedia, communication and computing device, incoming communication data;
notifying the user about the incoming communication data.

48. The method of claim 47, the method further comprising:
receiving, by the processor of the wearable personal digital flexible cloud game, multimedia, communication and computing device, a user command in response to the incoming communication data; and
displaying the incoming communication data on the display of the wearable personal digital flexible cloud game, multimedia, communication and computing device.

49. The method of claim 48, the method further comprising:
generating an audible sound in a sound generating unit of the wearable personal digital flexible cloud game, multimedia, communication and computing device, wherein the sound corresponds to the incoming communication data.

50. The method of claim 44, wherein the communication is performed using one or more of the following: a Bluetooth module, a communication port, including a universal serial bus (USB) port, a parallel port, an infrared transceiver port, and a radiofrequency transceiver port.

51. The method of claim 44, the method further comprising transferring, by the processor of the wearable personal digital flexible cloud game, multimedia, communication and computing device, the game and multimedia data or the communication data to a digital eyeglass device, a television set, a set-top box, a computer, a laptop, a smartphone, or a wearable personal digital device.

52. The method of claim 44, wherein the network includes one or more of the following: GSM, CDMA, LTE, IMS, Universal Mobile Telecommunication System (UMTS), RFID, 4G, 5G, 6G and upper.

53. A method for facilitating payments using a wearable personal digital flexible cloud game, multimedia, communication and computing device, the wearable personal digital flexible cloud game, multimedia, communication and computing device comprising the wearable personal digital flexible cloud game, multimedia, communication and computing device of claim 1, and the method comprising:
receiving a user request to display data associated with a user on a display of the wearable personal digital flexible cloud game, multimedia, communication and computing device, the data being stored in a memory unit of the wearable personal digital wearable personal digital flexible cloud game, multimedia, communication and computing device or on a data server;
displaying the data associated with the user on the display of the wearable personal digital flexible cloud game, multimedia, communication and computing device.

54. The method of claim 53, wherein the data is payment data associated with the user, the payment data being a barcode encoding a payment account information of the user; and
wherein the barcode is scannable by one or more of the following: a checkout scanner, a mobile device, a camera, or another wearable personal digital device.

55. The method of claim 53, wherein the data is personal data associated with the user, the personal data being a barcode encoding one or more of the following: a ticket, a boarding pass, a coupon, a discount card, a membership card, an identification (ID) card, a driver's license, a permanent resident card, and other cards.

56. The method of claim 55, wherein the barcode is scannable by one or more of the following: a checkout scanner, a mobile device, a camera, a check-in scanner, or another wearable personal digital device.

57. The method of claim 53, the method further comprising:
receiving a user request to scan a product barcode;
scanning the product barcode;
receiving a user request to generate a payment barcode, the payment barcode encoding at least product information;
generating the payment barcode;
displaying the payment barcode on the display of the wearable personal digital flexible cloud game, multimedia, communication and computing device, the displayed payment barcode being scannable by one or more of the following: a checkout scanner, a mobile device, a camera, a check-in scanner, or another wearable personal digital device.

58. The method of claim 57, the method further comprising retrieving, by the device, data on products similar to the scanned products and displaying the retrieved data about the similar products available from providers of the similar products.
